(19) United States
(12) Patent Application Publication
(10) Pub. No.: US 2009/0047014 A1
(43) Pub. Date: Feb. 19, 2009

(54) Optical transmitting module and a method to sense a fluctuation of light emitted from the same

(76) Inventor: Takeshi Irie, Yokohama-shi (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/071,922

(22) Filed: Feb. 27, 2008

(30) Foreign Application Priority Data
Feb. 28, 2007 (JP) 2007-050188

(51) Int. Cl. H04B 10/08; G01J 4/00

(52) U.S. Cl. 398/23; 356/364

(57) ABSTRACT

An optical transmitter is disclosed. The transmitter provides, in addition to a semiconductor laser diode as a light source, a variable polarizer with a Farady rotator and a polarization analyzer on an optical path of the laser diode. When the wavelength of the emitted light from the laser diode shifts, by adjusting the rotation angle of the Farady rotator by the current supplied to the coil so as to align the rotation angle with the polarization plane of the polarization analyzer, the wavelength shift of the laser diode may be estimated. Also, by comparing the optical magnitude between the initial of the operation and after the long-time operation at the output from the polarization analyzer after the alignment of the rotation angle of the Farady rotator, the degradation of the laser diode is detected.

### BACKGROUND OF THE INVENTION

1. Field of the Invention

The present invention relates to an optical transmitting module applicable in an optical communication system of a long distance, and to a method to sense a fluctuation of a wavelength of light emitted from the optical module and a degradation of the optical module.

2. Related Prior Art

An optical module used in an optical communication system with a long distance is necessary to be stable in the optical output power in long period. Accordingly, such an optical module detects a fluctuation of the optical output power of the laser diode (LD) installed within the module as a light source by a photodiode (PD). Depending on the fluctuation of the output power, the module adjusts a current supplied to the LD to maintain the optical output power in stable. In a high-capacity optical communication system, such as wavelength division multiplexed (WDM) system, it is necessary to keep the wavelength of the light emitted from the module in stable because the WDM system transmits a plurality of optical signals each attributed with different wavelengths in a single fiber.

When the optical module detects the degradation of the LD through a reduction of the optical output power, the optical module increases the current supplied thereto to increase the optical output power. However, the increment of the current accompanies with the heat generation, which shifts the output wavelength of the LD in a longer side. Accordingly, the optical module applied in the WDM system is necessary to detect both the optical output power and the output wavelength.

A Japanese Patent Application published as JP-2003-209317A has proposed an arrangement to compensate the wavelength shift and the power degradation of the LD, in which, placing a wavelength selective filter with an aperture on a path of the LD, a first PD detects the light passing through the aperture, not affected by the wavelength selective filter to obtain a variation of the optical output power, while a second PD detects the light passing through the wavelength selective filter to obtain a variation of the optical output power within a preset wavelength range.

An other Japanese Patent Application published as JP-2002-00443A has disclosed an arrangement, in which, placing an optical filter with the transmittance depending on the wavelength on a front optical path of the LD and an optical modulator with an electro-absorption type on a rear optical path of the LD, a first PD monitors the transmitted light to detect the wavelength shift, while, a second PD monitors the transmitted light from the modulator to detect the change in the optical output power.

However, those arrangements disclosed in prior documents are necessary to provide a plurality of PDs, which makes the optical system complex and is necessary to optically align two PDs. Moreover, the method to detect the wavelength shift through the optical power within a preset range determined by the wavelength selective filter is inherently inferior in the accuracy.

Further, the optical active device, such as the optical modulator, is placed on the optical path of the LD, inevitably increases the optical coupling loss. Other devices or means, such as to increase the driving current and to insert an optical amplifier on the optical path, are necessary to compensate this coupling loss, which also makes the system complex and thus increases the cost thereof.

### SUMMARY OF THE INVENTION

One aspect of the present invention relates to an optical transmitter module that includes a semiconductor laser diode, a photodiode, a variable polarizer, and a polarization analyzer. The photodiode is configured to monitor an optical output emitted from said semiconductor laser diode. The variable polarizer, which is disposed between the semiconductor laser diode and the photodiode, transmits the light emitted from the semiconductor laser diode and rotates a polarization plane of the light emitted therefrom by an angle dependent on a wavelength of the light. The polarization analyzer, which is disposed between the variable polarizer and the photodiode, has a specific polarization angle. In the present invention, by aligning the polarization plane of the light transmitted through the variable polarizer with the polarization plane of the polarization analyzer, the wavelength shift of the light emitted from the laser diode may be determined from a magnitude to align the polarization plane of the variable polarizer with that of the polarization analyzer.

An other aspect of the present invention relates to a method to evaluate the degradation of the laser diode that emits light with a wavelength by an optical system including a variable polarizer configured to rotate a polarization plane of the light variably, a polarization analyzer configured to receive light transmitted through the variable polarizer and to have a detectable polarization plane and a photodiode configure to detect light transmitted through the polarization analyzer. The method according to the invention comprises steps of: (a) determining a first power P₀ of the light at a beginning of an operation of the laser diode by aligning the polarization plane of the light transmitted through the variable polarizer with the polarization plane of the polarization analyzer; (b) determining a second power P₁ of the light after an operation of the laser diode by aligning the polarization plane of the light transmitted through the variable polarizer with the polarization plane of the polarization analyzer; and (c) determining the degradation of the laser diode by comparing the first power P₀ with the second power P₁.

### BRIEF DESCRIPTION OF DRAWINGS

FIG. 1 shows a block diagram of an optical transmitting module according to an embodiment of the present invention; and

FIG. 2 explains a method to detect a wavelength shift of light emitted from the optical transmitting module and to sense degradation of a light source in the optical transmitter module.

### DESCRIPTION OF PREFERRED EMBODIMENTS

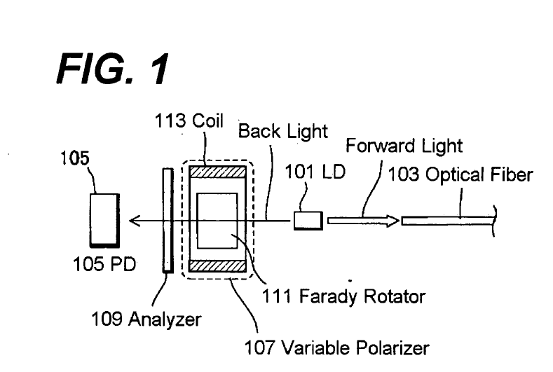

FIG. 1 schematically shows a functional block diagram of an optical transmitting module according to an embodiment of the present invention. The light emitted from one facet of the LD 101 couples with an optical fiber 103. We may call this light as the forward light; while, the light from the other facet of the LD 101 may be called as the back light. On the optical axis of the back light is positioned with the PD 105. On the optical axis of the back light and between the LD 101 and the PD 105 is positioned with a variable polarizer 107 with a function to vary the polarization angle thereof, and on the optical axis of the back light between the polarizer 107 and the PD 105 is placed with a polarization analyzer 109. This variable polarizer 107 includes a Farady rotator 111 whose rotation angle of the polarization depends on both the magnetic field applied thereto and the wavelength of the light passing therethrough.

The back light enters the PD 106 after the polarization is rotated by the polarizer 107 and passes through the polarization analyzer 109. Initially, the polarization angle of the variable polarizer 107 and the polarization plane of the polarization analyzer 109 are aligned to each other so as to obtain the maximum coupling between the LD 101 and the PD 105. The polarization angle of the variable polarizer 107 may be adjustable by the magnetic filed induced by the coil 113 arranged around the Farady rotator 111. That is, the polarization angle of the variable polarizer 107 depends on the Farady rotation angle and this angle depends on the current provided to the coil 113. FIG. 1 shows an exemplary arrangement of the coil 113 where the conductive wire is cylindrically wound around the optical axis, within which is disposed with the Faraday rotator 111, but not restricted to those shown in FIG. 1. Other arrangement, in which at least the magnetic field may be induced along the optical axis, may be applicable.

First, assuming the initial optical power detected by the PD 105 to be P0 in the optical module shown in FIG. 1, and we detects the reduction of the output from the PD 105 after the practical operation of the optical module shown in FIG. 1. When the PD 105 detects the decrement of the optical power, the rotation angle of the Farady rotator 111 is adjusted such that the polarization angle of the light after passing the Farady rotator 111 matches with the polarization plane of the polarization analyzer 109 by varying the strength of the magnetic filed induced by the coil 113, which is substantially identical with the operation that the output of the PD 105 becomes the maximum. Accordingly, the shift of the wavelength of the light emitted from the LD 101, which is reflected in the rotation of the polarization angle of the Farady rotator 111, may be cancelled. The magnitude of the current supplied to the coil 113 reflects the shift of the rotation angle of the Farady rotator 111.

The Farady rotation angle α1 (radian) is denoted by:

α1=V·H·L, (1)

where H [A/m] is the magnetic field strength, L [m] is the length through which the polarized light passes and V [radian/A] is a Verdet constant depending on the wavelength of the light. Assuming w1 [nm] is the wavelength of the light at the initial operation of the LD 101, w2 [nm] is that after the long-term operation and the wavelength dependence of the Verdet constant is a [radian/A/nm], the Farady rotation angle α2 after the long-term operation becomes;

α2=(a·(w2−w1)+V)·H·L. (2)

Thus, the magnetic field strength to recover the Farady rotation angle given by equation (2) to a value given by equation (1) becomes;

H2=V·H/(V+a·(w2−w1)). (3)

Specifically, in a case where a thickness of the Farady rotator is 0.5 [nm], the Verdet constant is 0.05 [radian/A], and the wavelength dependence of the Farady rotation angle is 1 [deg/nm], the magnetic field strength to recover the Farady rotation angle, when the wavelength of the light varies by 1 nm, becomes H=n/180/0.5×10⁻³/0.05˜700 [A/m]. The coil with 2000 turns may show this field strength by supplying the current of about 350 [mA].

When the optical power detected with the PD 105 becomes P1 after recovering by LP according to the operation of the Farady rotator mentioned above, this recovered power ΔP corresponds to the reduction by the rotation of the Farady rotator due to the shift of the wavelength. Because the Farady rotation angle depends on the wavelength of the light passing therethrough, we can estimate the shift in the wavelength through this rotation angle. That is, the shift in the wavelength may be estimated through the current supplied to the coil 113 to cancel the Farady rotation angle. Moreover, when the power P1 is less than P0, the initial power detected by the PD 105, a difference between P1 and P0 corresponds to the degradation of the output power of the LD independent of the wavelength.

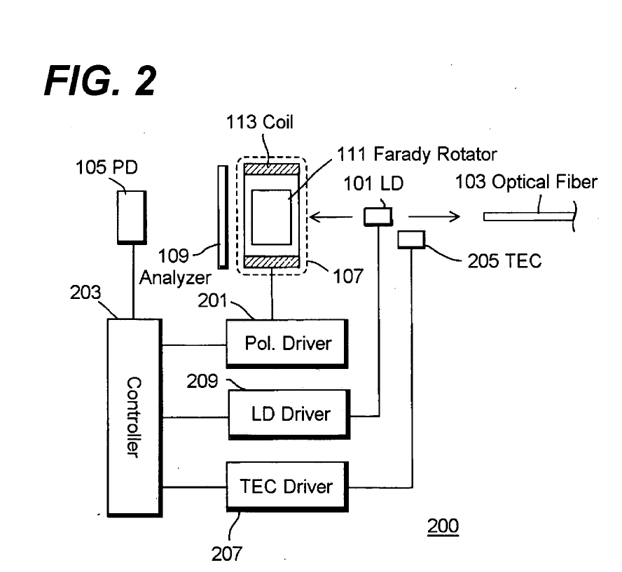

FIG. 2 schematically shows the functional block of the optical transmitting module that is able to detect the shift of the wavelength and the degradation in the optical output of the LD. The optical module shown in FIG. 2 provides the polarizer driver 201 that adjusts the current supplying to the coil 113 depending on the optical output power detected by the PD 105. As described, the current supplied to the coil 113 varies the magnetic field affected to the Farady rotator, which affects the rotation angle of the polarization. Thus, the controller may cancel the rotation angle of the polarization due to the shift of the wavelength emitted from the LD 103 by adjusting the current supplied to the coil 113. That is, the controller 203 adjusts the rotation angle of the polarization of the light emitted from the LD 103 and passing through the Farady rotator such that the rotation angle of the light matches with the polarization plane of the polarization analyzer as receiving the output from the PD 105. The controller 203 may estimate the shift of the wavelength through the magnitude of the current supplied to the coil 113 to cancel the shift of the polarization angle. The module further provides a temperature controller 205, such as thermo-electric controller (TEC), to adjust the temperature of the LD 103, which is connected to and controlled by the controller 203. The controller 203 may adjust the wavelength of the light emitted from the LD 103 to be a preset value based on thus detected shift thereof by commanding the TEC driver 207 that drives the TEC 205.

The controller may estimate the degradation of the LD 103 by comparing the optical output power detected by the PD 105 at the initial condition, which is obtained after the adjustment of the Farady rotation angle so as to align the polarization plane of the polarization analyzer 109, with the output power after the long-time operation that is obtained after the adjustment of the Farady rotation angle so as to generate the maximum output by the PD 105. When the comparison thus performed indicates the degradation of the LD 103, the controller 203 commands the LD-driver 209 to increase the optical output power thereof to compensate this degradation.

The controller 203, in addition to the function to evaluate the shift of the wavelength of the emitted light through the current supplied to the coil, may provide functions to hold the conditions of the LD 103, namely, the shift of the wavelength and the extent of the degradation, to set alarms to the outside of the module when the detected shift of the wavelength or the evaluated degradation of the LD 103 exceeds preset thresholds. Moreover, the module 200 may further provide a temperature sensor to monitor the temperature of the Farady rotator 111 and the controller 203 may enhance the accuracy of the evaluation of the shift of the wavelength from the current to the coil 113. Although the embodiment above mentioned applies the Farady rotator as the variable polarizer, the optical module may apply a liquid-crystal whose polarization angle may be varied by the electric field applied thereto.

What is claimed is:

1. An optical transmitter module, comprising:
a semiconductor laser diode;
a photodiode configured to monitor an optical output emitted from said semiconductor laser diode;
a variable polarizer disposed between said semiconductor laser diode and said photodiode to transmit said light emitted from said semiconductor laser diode, said variable polarizer rotating a polarization plane of light emitted from said semiconductor laser diode by an angle dependent on a wavelength of said light; and
a polarization analyzer disposed between said variable polarizer and said photodiode, said polarization analyzer having a specific polarization angle.

2. The optical transmitting module according to claim 1,
wherein said angle of said polarization plane of said variable polarizer is rotated so as to match said specific polarization angle of said polarization analyzer.

3. The optical transmitting module according to claim 2,
wherein said variable polarizer provides a Farady rotator and a coil surrounding said Farady rotator, said angle of said polarization plane of said variable polarizer being rotated by a magnetic filed generated by said coil.

4. A method to detect a wavelength shift of light emitted from a semiconductor laser diode, said method comprising steps of:
transmitting said light through a variable polarizer dispose so as to receive said light of said semiconductor laser diode, said variable polarizer providing a Farady rotator to pass said light and a coil surrounding said Farady rotator;
analyzing an angle of a polarization plane of light transmitted through said Farady rotator by a polarization analyzer disposed so as to receive said light transmitted said Farady rotator; and
setting said polarization plane of said light transmitted through said Farady rotator to be substantially equal to a polarization plane of said polarization analyzer by providing a current to said coil,
wherein said wavelength shift of said light emitted from said laser diode is determined from the current provided to said coil.

5. A method to detect a degradation of a semiconductor laser diode that emits light by a system including a variable polarizer configured to rotate a polarization plane of said light variably, a polarization analyzer configured to receive light transmitted through said variable polarizer and to have a detectable polarization plane and a photodiode configure to detect light transmitted through said polarization analyzer, comprising steps of:
determining a first power of said light at a begging of an operation of said laser diode by aligning said polarization plane of said light transmitted through said variable polarizer with said polarization plane of said polarization analyzer;
determining a second power of said light after an operation of said laser diode by aligning said polarization plane of said light transmitted through said variable polarizer with said polarization plane of said polarization analyzer; and
determining said degradation of said laser diode by comparing said first power with said second power.

6. The method according to claim 5,
wherein said variable polarizer provides a Farady rotator and a coil surrounding said Farady rotator, and
wherein said step for aligning said polarization plane of said light transmitted through said variable polarizer with said polarization plane of said polarization analyzer is performed by adjusting a current supplied to said coil.
